(19) United States
(12) Patent Application Publication
(10) Pub. No.: US 2024/0144042 A1
(43) Pub. Date: May 2, 2024

(54) TRAINING A TEAM PREDICTION MODEL TO GENERATE VIRTUAL TEAMS

(71) Applicant: Microsoft Technology Licensing, LLC, Redmond, WA (US)

(72) Inventors: Torbjørn HELVIK, Oslo (NO); Vikramjeet Singh JASSAL, Oslo (NO); Mohammadreza BONYADI, Trondheim (NO); Andreas Schmidt JENSEN, Copenhagen (DK); Lene C. RYDNINGEN, Berlin (DE)

(21) Appl. No.: 18/051,867

(22) Filed: Nov. 1, 2022

(51) Int. Cl. G06N 5/02

(52) U.S. Cl. CPC G06N 5/022

(57) ABSTRACT

A candidate virtual team is generated using a team prediction model. The team prediction model is trained based on user feedback. Activity data of a user is collected, the activity data is associated with activities in which the user and a set of other users have engaged. A candidate virtual team associated with the collected activity data is generated using a team prediction model and the candidate virtual team is presented to the user using an interface. User feedback data associated with the generated candidate virtual team is received from the user. The team prediction model is trained using the received user feedback data, whereby accuracy of future generated candidate virtual teams generated by the team prediction model is improved during the training. The training of the team prediction model based on user feedback improves the generation of virtual teams over time.

### BACKGROUND

Many companies maintain organizational structure based on reporting relationships. However, in many companies, much of the work happens in other arrangements of people that do not necessarily follow these organizational boundaries. Such cross-organization collaboration efforts can be referred to as “virtual teams”. It is challenging to track and accurately display information about virtual teams that form within organizations because such virtual team relationships are often formed in an organic or dynamic manner as various employees interact with each other.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for generating a candidate virtual team using a team prediction model and training the team prediction model based on user feedback is described. Activity data of a user is collected, the activity data associated with activities in which the user and a set of other users have engaged. A candidate virtual team associated with the collected activity data is generated using a team prediction model and the candidate virtual team is presented to the user using an interface. User feedback data associated with the generated candidate virtual team is received from the user. The team prediction model is then trained using the received user feedback data, whereby accuracy of future generated candidate virtual teams generated by the team prediction model is improved during the training.

### BRIEF DESCRIPTION OF THE DRAWINGS

The present description will be better understood from the following detailed description read in light of the accompanying drawings, wherein:

FIG. 1 is a block diagram illustrating an example system configured to predict candidate virtual teams using a team prediction model, and training the model based on user feedback;

FIGS. 2A-B are diagrams illustrating an example candidate virtual team display and an example virtual team editing display for displaying candidate virtual teams to users and for collecting user feedback from users;

FIG. 3 is a diagram illustrating an example posted virtual team display for displaying posted virtual teams to users;

FIG. 4 is a flowchart illustrating an example computerized method for generating a candidate virtual team using a team prediction model and training the team prediction model based on user feedback data;

FIG. 5 is a flowchart illustrating an example computerized method for generating a candidate virtual team using a team prediction model and enabling the user to edit the candidate virtual team; and

FIG. 6 illustrates an example computing apparatus as a functional block diagram.

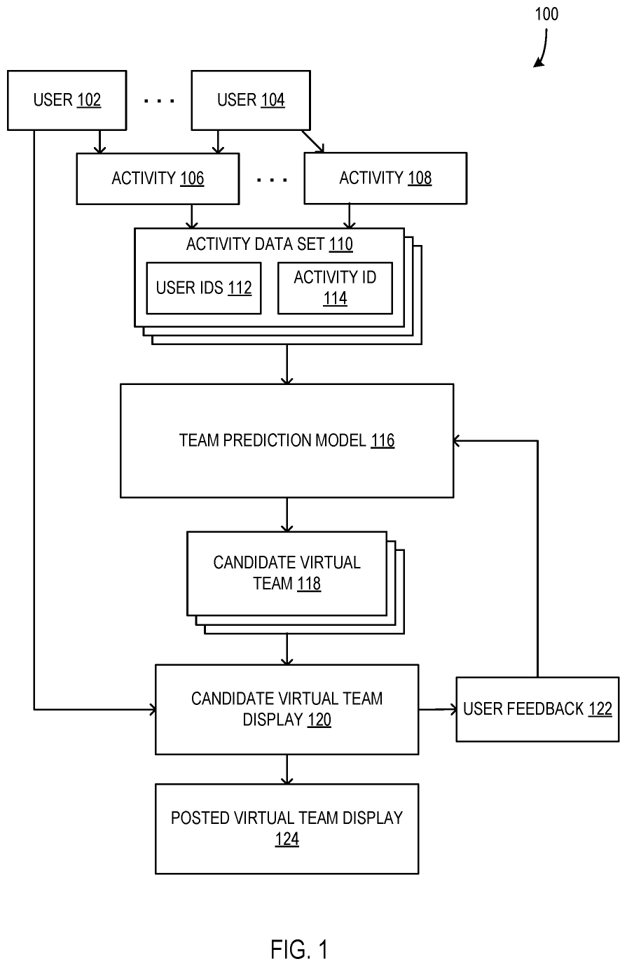

Corresponding reference characters indicate corresponding parts throughout the drawings. In FIGS. 1 to 6, the systems are illustrated as schematic drawings. The drawings may not be to scale. Any of the figures may be combined into a single example or embodiment.

### DETAILED DESCRIPTION

Aspects of the disclosure provide a computerized method and system for generating a candidate virtual team using a team prediction model, and training that model using user feedback associated with the generated candidate virtual team. The disclosure describes collecting activity data associated with one or more users and providing the collected activity data to the team prediction model as input. At least one candidate virtual team is generated by the team prediction model using the provided activity data. The candidate virtual team is displayed or otherwise presented to a user. The user provides feedback on the candidate virtual team. The user feedback can include an acceptance indicator, a rejection indicator, virtual team editing data, or the like. The user feedback is used as feedback data for training the team prediction model to generate a future candidate virtual team more accurately. Further, the user is enabled to post or publish a candidate virtual team that is accepted, enabling another user to view or otherwise access information about the posted or published virtual team.

The disclosure operates in an unconventional manner at least by enabling candidate virtual teams to be generated by the team prediction model, and then for the team prediction model to be trained and/or fine-tuned using the user feedback to those candidate virtual teams. These features enable collaboration between users on different conventional teams within an organization to be automatically detected and associated with a candidate virtual team. The potential members of the candidate virtual team are provided the option to accept and use the virtual team as described herein. Such automatically generated virtual teams improve computational efficiency and security of communications between collaborating users. For example, management of computational resources is improved, and usage of the computational resources is reduced, at least by eliminating redundant communications (e.g., resending messages to collaborating users that were accidentally not included in a first set of messages, sending messages to users that are not part of a virtual team, etc.). Further, the time and computational resource costs associated with determining the set of users that are collaborating on a particular project or for a particular purpose are reduced when a virtual team identifying those users is automatically generated by the team prediction model and posted or published by those users. Additionally, in some examples, published virtual teams can be exposed to tools like enterprise search systems or organizational browsers. This can lead to more transparency around ongoing activities in the organization, making it easier for employees to connect to the correct people as well as for the organization to identify duplicate or near-duplicate efforts.

Further, the disclosure describes the team prediction model being improved over time using the user feedback to generated candidate virtual teams and machine learning techniques. In this manner, the accuracy of the team prediction model is improved over time, and, in some cases, the team prediction model is trained to better fit the particular organization with which it is being trained. Over time, these performance increases result in better candidate virtual teams that are accepted as accurate by the users more frequently. Additionally, in some cases, the team prediction model is trained to detect collaborations between users that will result in an accepted candidate virtual team more quickly, resulting in such virtual teams being posted and used with less usage of computational resources. All these features contribute to increased efficiency of use of system resources due to a reduction of redundant or otherwise technically inefficient efforts to organize and/or communicate with a precise set of collaborating users that are otherwise not associated with the same conventional team within the organization.

The disclosure further describes a system that enables a user to visualize virtual teams with which they are associated and/or candidate virtual teams that they can review, accept, reject, edit, or the like. Such virtual teams can further be posted or published to a set of public virtual teams that can then be viewed by other users via similar visual interfaces. Further, users are enabled to interact with members of a public virtual team via such interfaces, including emailing or otherwise messaging the members of the virtual team as a single action, accessing and/or reviewing documents or other items produced by the virtual team, or the like. The disclosure describes accessing such public virtual teams by viewing member profiles or searching for virtual teams by title, activity, keyword, or the like.

Additionally, or alternatively, the disclosure enables users that are members of virtual teams to organize communications, documents, and/or other items associated with those virtual teams, including, for instance, providing the users with virtual team-specific feed interfaces that highlight or otherwise notify users of activities that are occurring in association with the virtual team (e.g., emails from members of the virtual team are displayed in the feed, documents that are uploaded in association with the virtual team are linked in the feed, etc.).

It should be understood that, in addition to the team prediction model generating candidate virtual teams for user review, in other examples, users are also enabled to create candidate virtual teams on their own (e.g., using a described interface to provide a team title, select members, and link any appropriate documents, items, or keywords). In such examples, those virtual teams created by the users are used as feedback for use in training the team prediction model in the same manner as the user feedback from generated candidate virtual teams is used without departing from the description.

As described herein, a virtual team is in contrast to what may be referred to herein as a conventional team, a company-assigned team, an official team, a traditional team, a formal team, or the like. In some examples, a virtual team is defined outside of, or without conforming to, an employment hierarchy.

As described herein, a virtual team is predicted. Other terms for describing predicting in this context include generating, deducing, observing, and the like.

FIG. 1 is a block diagram illustrating a system 100 configured to predict candidate virtual teams 118 using a team prediction model 116 and training that model 116 based on user feedback 122. In some examples, users 102-104 engage in activities 106-108 from which activity data sets 110 are generated. The team prediction model 116 analyzes the activity data sets 110 to generate candidate virtual teams 118 which include sets of users 102-104 and/or other virtual team-related data. The activity data sets 110 include, for example, keywords, activities and/or general activity types. The candidate virtual teams 118 are displayed to one or more users 102-104 via a candidate virtual team display 120 and the users 102-104 viewing the candidate virtual teams 118 provide user feedback 122 indicating whether the candidate virtual teams 118 include accurate lists of users 102-104 who are members. The user feedback 122 is used to improve the team prediction model 116 using machine learning techniques as described herein. Candidate virtual teams 118 that are found to be accurate using the candidate virtual team display 120 are then “posted” or otherwise confirmed for display to other users in the organization via a posted virtual team display 124.

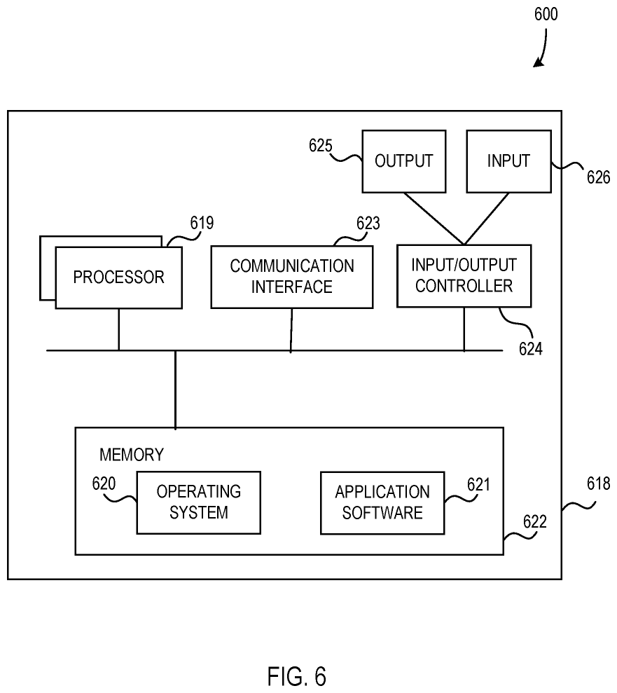

In some examples, the system 100 includes a computing device (e.g., the computing apparatus of FIG. 6). Further, in some examples, the system 100 includes multiple computing devices that are configured to communicate with each other via one or more communication networks (e.g., an intranet, the Internet, a cellular network, other wireless network, other wired network, or the like). In such examples, entities of the system 100 are configured to be distributed between the multiple computing devices and to communicate with each other via network connections. In an example, the team prediction model 116 is located and/or executed on a first computing device or set of computing devices while the users 102-104 engage in activities 106-108 using a second set of computing devices. The second set of computing devices are configured to communicate with the computing device(s) of the team prediction model 116 via a network connection as described herein. In other examples, other organizations or arrangements of computing devices are used to enable the operations of the system 100 without departing from the description.

In some examples, users 102-104 are people that make use of the system 100 to perform or otherwise engage in activities 106-108 in some form. In such examples, users 102-104 include users that are all members of the same organization, such as employees of a company or other entity. Alternatively, or additionally, users 102-104 include users that are not members of the same organization, but are users of the same platform, such as users of a social media platform or the like. Further, in some examples, users 102-104 engage in activities 106-108 using computing devices with which data associated with those activities 106-108 can be recorded and/or stored as activity data sets 110.

In some examples, activities 106-108 performed by or otherwise associated with users 102-104 include activities in which multiple users engage in a collaborative manner. In some examples, activities 106-108 include communication activities such as the sending of email, text messages, instant messages, or the like back and forth between users; meetings, appointments, and/or other events held with multiple users in attendance; tasks or projects assigned to one user by another user; or the like. Additionally, or alternatively, activities 106-108 include the creation, editing, viewing, and/or submitting of documents or other deliverable files or items by one or more users 102-104. In an example, an activity 106 includes the drafting of a report by users 102 and 104 for submission to a client of a company for which users 102 and 104 are employed. Still further, activities 106-108 include activities that are performed in the completion of larger projects of tasks, and the engagement in and/or completion of these activities produce documents, communications, and/or other data that is included in the associated activity data sets 110.

In some examples, for each activity 106-108, there is an activity data set 110. An activity data set 110 of an activity 106-108 includes user identifiers (IDs) 112 of the users 102-104 that engaged in the activity and an activity ID 114 that identifies the activity. In some examples, the activity ID 114 uniquely identifies an activity among other activities. In other examples, the activity ID 114 corresponds to a category, group, association, class, type, etc. of activity. Additionally, or alternatively, the activity data set 110 and/or the activity ID 114 specifically includes an activity type ID that indicates the type of the activity (e.g., an email exchange activity type, a meeting activity type, a task assignment activity type, a document generation activity type, or the like). Further, in some examples, an activity data set 110 includes other data associated with the activity 106-108 that describes features of the activity, includes results or output of the activity, such as documents generated by the activity, or the like. In an example of an activity data set 110 of a meeting activity 106, the activity data set 110 includes the user IDs 112 of the attendees of the meeting, data indicating the user that arranged the meeting, data indicating the date and/or time of the meeting, data describing the minutes or other content of the meeting, transcript data of the meeting, data describing an email chain or similar communication data about the meeting, or the like.

Further, in some examples, an activity data set 110 includes data linking the associated activity to other activities 106-108. In an example, an activity data set 110 associated with a document generation activity includes an activity ID of a related activity 106-108 in which a user assigned a task to another user to perform the document generation activity. In this way, the task assignment activity that led to the performance of the document generation activity is linked to the activity data set 110. In another example, a meeting activity includes activity IDs of a series of other activities, such as document generation and/or review activities, that stemmed from the associated meeting. Such linking between activities can be used by the team prediction model 116 during the generation of candidate virtual teams 118 as described herein.

In some examples, the activity data sets 110 of the system 100 are collected into a data store, such as a database or the like, when they are generated and then the activity data sets 110 are provided to the team prediction model 116 to generate new candidate virtual teams 118. In such examples, the team prediction model 116 is used to generate new candidate virtual teams 118 periodically. In an example, the system 100 is configured to use the team prediction model 116 to generate new candidate virtual teams 118 once per day, once every twelve hours, once a week, or the like. Alternatively, or additionally, the system 100 is configured to use the team prediction model 116 to generate new candidate virtual teams 118 based the occurrence of events. In an example, the generation of new candidate virtual teams 118 is triggered when a quantity of new activity data sets 110 exceeds a defined threshold. For example, if the quantity of activity data sets 110 that have been collected and not yet used to generate candidate virtual teams 118 exceeds 100, the use of those activity data sets 110 by the team prediction model 116 to generate candidate virtual teams 118 is triggered.

In some examples, the team prediction model 116 is a model that is generated using machine learning techniques to generate candidate virtual teams 118 from activity data sets 110 as described herein. In such examples, the team prediction model 116 is trained to group sets of users 102-104 together into one or more candidate virtual teams 118 based on how those users 102-104 interact with each other as described in the activity data sets 110. In some examples, the quantity of activities that two users share in the set of activity data sets 110 influences the likelihood that the two users will be placed onto the same candidate virtual team 118 by the team prediction model 116. Additionally, or alternatively, two users that engage in similar or the same types of activities frequently are more likely to be placed onto the same candidate virtual team 118 by the team prediction model 116.

Further, in some examples, the team prediction model 116 is configured to generate and/or adjust a graph data structure of users 102-104 and/or other entities (e.g., documents generated, modified, or otherwise interacted with during activities) as nodes of the graph and edges between nodes representing relationships between those users and/or other entities. Further, the team prediction model 116 is configured to assign weights to some or all nodes of the graph. Such weights represent the degree to which relationships to the weighted node are indicative that the user nodes connected to the weighted node are on a virtual team with each other. In an example where a first user node and a second user node are both connected to a node associated with a document generated by the user of the first user node and viewed by the user of the second user node, the weight assigned to the node associated with the document is used by the team prediction model 116 to determine whether the user of the first user node and the user of the second user node are on the same virtual team. It should be understood that, in most examples, many weighted nodes are analyzed to determine whether two users should be associated with each other in a candidate virtual team 118.

Additionally, in such examples, the team prediction model 116 is configured to determine the strengths of relationships between nodes in the graph based on the weights applied to the nodes therein. Factors that are considered when determining the strength of a relationship include, but are not limited to, the semantic similarity between the subject matter of the items represented by the nodes, the amount of time the user spent on the item represented by a node (e.g., how much time a user spent on a document), the recency of the interaction(s) with the items within the focus time period, the number of interactions, the people involved, and the subject matter of the communications and tasks such as where related subject matter produces a stronger relationship. Another factor may be the number of overlaps between the people involved. Further, in some examples, the weights of the nodes impact the relationship strength considerations, where the weights can be positive or negative. A positive weight is used to increase the strength of a relationship, while a negative weight is used to decrease the strength of the relationship.

Further, in some examples, the team prediction model 116 is configured to group the user nodes of the graph data structure into one or more virtual team based on the determined strengths of relationships therebetween. These one or more virtual teams are then provided as output of the team prediction model 116 in the form of candidate virtual teams 118.

The AI problem of predicting teams is treated as a clustering problem, also known as a community prediction problem in the graph research literature. Many different approaches to such problems can be used. In some examples, the team production model 116 consists of a sequence of steps, where the first step weights activities according to their importance, the second step creates a weighted graph between users based on the activities, the third step identifies candidate virtual teams as communities in this graph, and the fourth step assesses each candidate virtual team and decides which ones to suggest to the end user. Some of these steps can be implemented using neural network-based machine learning models. It should be understood that, in other examples, the team prediction model 116 is configured as a different type of machine learning-based model or set of models without departing from the description.

In some examples, the candidate virtual teams 118 are data structures that each include one or more user IDs 112 of users that are predicted to be on the associated virtual team 118. Further, in such examples, the candidate virtual teams 118 include other data, such as context data that is indicative of activities that influenced the relationships of the members of the candidate virtual team 118. In an example, if a candidate virtual team 118 is generated based on the members all frequently engaging in the same type of activity, the candidate virtual team 118 includes data that indicates that the team is associated with that type of activity, such as a keyword or tag associated with that type of activity. Additionally, or alternatively, in another example, if a candidate virtual team 118 is generated based, at least in part, on all the members frequently meeting on the same day and/or time over a period, the candidate virtual team 118 includes data that refers to the standing meeting between the team members, such as a weekly meeting time entry that is displayed to members of the team and/or other users that view the team if it is posted as described herein. Further, in some examples, the candidate virtual teams 118 are generated based on other types of context data associated without departing from the description.

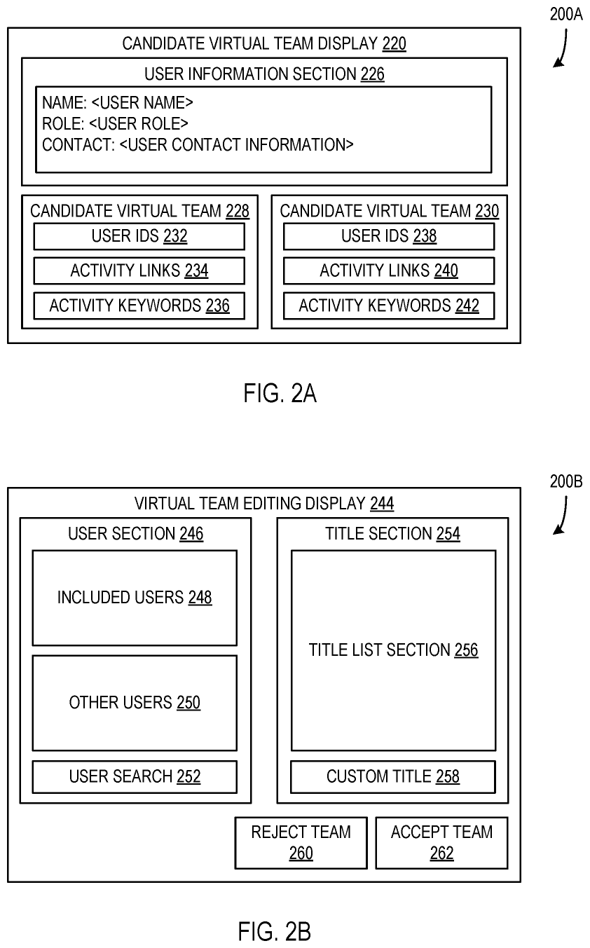

In some examples, the candidate virtual team display 120 is a user interface, such as a graphical user interface (GUI), configured to display information describing candidate virtual teams 118 and the members of those teams 118. Further, the display 120 is configured enable the members to confirm the accuracy of the displayed candidate virtual teams 118, reject the displayed candidate virtual teams as inaccurate, and/or edit the displayed candidate virtual teams 118 to improve their accuracy. The feedback provided to the system 100 via the display 120, including the confirmation of accuracy, rejection based on inaccuracy, and/or edits made to improve the accuracy, is used as user feedback 122. The user feedback 122 is used to adjust and/or improve the performance of the team prediction model 116 using machine learning techniques. Additionally, or alternatively, the candidate virtual team display 120 includes more, fewer, or other types of data associated with the candidate virtual teams 118 and/or members thereof without departing from the description. An example of the candidate virtual team display 120 is described below with respect to FIGS. 2A-B. Additionally, or alternatively, in some examples, the candidate virtual display 120 includes a non-graphical interface for providing candidate virtual teams 118 to users 102-104, such as a command line interface that provides candidate virtual team information in text form and/or an audio interface that provides candidate virtual team information in an audible form. In other examples, other types of interfaces are used to provide candidate virtual team information to users without departing from the description.

In some examples, the user feedback 122 includes feedback provided by users 102-104 in response to the generated candidate virtual teams 118. In such examples, the user feedback 122 includes data provided by users associated with the candidate virtual teams 118 as described above, such as confirmation that a team 118 is accurate, indication that a team 118 is inaccurate, and/or edits made by users to improve the accuracy of a team 118. The user feedback 122 is used to adjust or otherwise change the team prediction model 116 in order to cause the team prediction model 116 to generate more accurate candidate virtual teams 118 in the future. Additionally, or alternatively, the team prediction model 116 is trained to better decide which candidate virtual teams should be shown as suggestions. In some examples, the weights of nodes within the team prediction model 116 are increased, decreased, or otherwise changed to alter how the team prediction model 116 generates candidate virtual teams 118. Further, in such examples, the team prediction model 116 is changed based at least in part on the user feedback 122 using machine learning techniques.

In some examples, the user feedback 122 is collected and stored in a data store. In such examples, the training of the team prediction model 116 is performed periodically and/or based on the occurrence of an event. In an example, the team prediction model 116 is trained or fine-tuned using user feedback 122 once per week. Alternatively, or additionally, in another example, the team prediction model 116 is trained or fine-tuned using user feedback 122 once the quantity of user feedback 122 stored in the data store exceeds a threshold quantity of instances (e.g., 1000 instances). Then, the stored user feedback 122 is moved to a different data store, resetting the trigger of the training process. In other examples, other arrangements for determining when to train the team prediction model 116 are used without departing from the description.

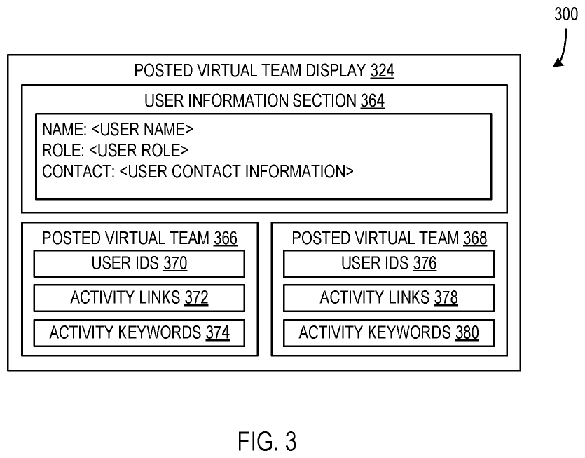

In some examples, the posted virtual team display 124 is an interface, such as a GUI, configured to display virtual teams that have been confirmed or otherwise accepted as accurate via the candidate virtual team display 120. Further, in such examples, the posted virtual team display 124 is configured to display data associated with members of a virtual team as well as other data associated with the virtual team, such as a team name, context data such as keywords or tags of the virtual team, contact information for the virtual team and/or the members thereof, or the like. An example of the posted virtual team display 124 is described below with respect to FIG. 3. Additionally, or alternatively, in some examples, the posted virtual display 124 includes a non-graphical interface for providing posted virtual teams to users, such as a command line interface that provides posted virtual team information in text form and/or an audio interface that provides posted virtual team information in an audible form. In other examples, other types of interfaces are used to provide posted virtual team information to users without departing from the description.

FIGS. 2A-B are diagrams 200A and 200B illustrating a candidate virtual team display 220 and a virtual team editing display 244 for displaying candidate virtual teams 228-230 to users (e.g., users 102-104) and for collecting user feedback (e.g., user feedback 122) from users. In some examples, the candidate virtual team display 220 is included in or otherwise associated with a system such as system 100 of FIG. 1.

The candidate virtual team display 220 as illustrated includes a user information section 226 and candidate virtual teams 228 and 230. It should be understood that, in other examples, the candidate virtual team display 220 includes more, fewer, or different sections, such as more candidate virtual teams or posted virtual teams that include the displayed user, without departing from the description.

The user information section 226 includes information about a user. As illustrated, the information includes the user's name, the user's role, such as a role in a company associated with the system, and the user's contact information. In some examples, the user information provided by the section 226 is associated with the user that is viewing the display 220. Alternatively, or additionally, in some examples, a user is enabled to view the profiles of some other users of the system, such that the user information section 226 displays user information associated with those other users.

Further, in some examples, the user information section 226 includes more, less, and/or different user information without departing from the description. In some examples, the user information section 226 includes data indicating the departments within the company with which the user is associated. Additionally, or alternatively, the section 226 includes links to profiles of other users with whom the displayed user is associated, such as members of an official team which the user leads or is otherwise a member of, and/or members of virtual teams that have been previously posted.

The candidate virtual teams 228 and 230 are displayed on the display 220 to prompt and/or enable the user to review and either reject or confirm the virtual teams 228-230 for posting. The displayed data of the candidate virtual teams 228-230 include user IDs 232 and 238, activity links 234 and 240, and activity keywords 236 and 242, respectively. The user IDs of a candidate virtual team display to the user the team members that have been selected for inclusion by the team prediction model 116. The activity links provide links that enable a user viewing the virtual team to view interfaces displaying information associated with activities performed by members of the virtual team. In an example, the activity links 234 include a link to an interface for viewing a report or other document generated by the members of the virtual team. The activity keywords include keywords that are descriptive of or otherwise associated with the activities performed by members of the virtual team. The activity keywords enable the virtual team to be found via a search once it is posted and for users viewing the virtual team to gain an understanding of the purpose of the virtual team.

In some examples, the data displayed about candidate virtual teams 228-230 includes more, less, or different data without departing from the description. Further, it should be understood that any data included in the candidate virtual teams 228-230 can be modified, added to, and/or removed (e.g., via a virtual team editing display 244 as described below) prior to rejecting or accepting the candidate virtual team without departing from the description.

Further, in some examples, the candidate virtual team display 220 is part of a larger display or other interface. In some examples, the display 220 is part of a user profile display that is configured to display other information to the user, in addition to information about the candidate virtual teams 228-230. Such other information includes communications directed to the user from other users, updates regarding progress on projects, tasks, or the like with which the user is associated, calendar information and/or associated information about upcoming meetings and/or appointments, or the like. In such examples, the user profile display is updated to include one or more candidate virtual teams when those teams are generated. Further, in such examples, the profile display prompts the user or otherwise highlights the displayed candidate virtual teams to encourage the user to review, reject, and/or accept the candidate virtual teams to be posted for other users to view.

In some examples, clicking on, or otherwise activating, a candidate virtual team displayed on the display 220 causes a virtual team editing display 244 to be displayed to the user. The virtual team editing display 244 as illustrated includes a user section 246, a title section 254, a reject team button 260, and an accept team button 262. The user section 246 includes included users 248, other users 250, and a user search 252 portion. The title section 254 includes a title list section 256 portion and a custom title 258 portion.

In some examples, the included users 248 of the user section 246 include the users that are currently defined as being part of the candidate virtual team being displayed. Initially, these are the users that are assigned to the candidate virtual team by the team prediction model 116 as described herein. Further, the other users 250 include users that were not included in the candidate virtual team by the team prediction model 116 but whom may still be likely to be part of the candidate team. In such examples, the users displayed in the other users 250 portion are those users with a greatest probability of being added to the candidate virtual team by the team prediction model 116 at some point. Additionally, or alternatively, the users in the other users 250 portion are users with whom the user viewing the virtual team editing display 244 frequently collaborates. Still further, the user search 252 enables the user viewing the display 244 to search for still other users by name, identifier, or the like to add those users to the included users 248 of the displayed candidate virtual team.

In some examples, the title list section 256 includes a list of suggested titles for the displayed candidate virtual team. In such examples, the titles listed in the title list section 256 are generated from the activities in which the members of the candidate virtual team typically engage with each other. Additionally, or alternatively, the titles listed are based on the names of teams or other organizational groups that the team members are already part of. The custom title 258 portion enables the user of the display 244 to enter a custom title for the displayed candidate virtual team.

In some examples, activating the reject team button 260 causes the associated candidate virtual team to be rejected and a rejection indicator is provided to the system as user feedback 122 for use in training the team prediction model 116. Further, activating the accept team button 262 causes the candidate virtual team to be accepted as a team that can then be posted by one or more users of the time for viewing by other users. The acceptance of the displayed candidate virtual team is also provided to the system as user feedback 122 for use in training the team prediction model 116. Additionally, or alternatively, any changes made by the user prior to accepting the candidate virtual team are provided to the system as user feedback 122 for use in training the team prediction model 116.

Further, in some examples, the virtual team editing display 244 includes more and/or different sections that enable the user to make changes to the displayed candidate virtual team. In some examples, the user is enabled to add to, remove, and/or change activity links and/or activity keywords of the candidate virtual team. In other examples, other changes to the candidate virtual team are enabled by the display 244 without departing from the disclosure.

Additionally, or alternatively, in some examples, rejection or acceptance of a candidate virtual team is based on more than one potential team member rejecting and/or accepting the candidate virtual team, respectively. In such examples, the candidate virtual team must be unanimously accepted by the members of the candidate virtual team for it to be posted for viewing by other users. Alternatively, or additionally, only a user or users with additional privileges, such as users in leadership positions, can accept, reject, and/or change a candidate virtual team unilaterally as described herein.

FIG. 3 is a diagram 300 illustrating a posted virtual team display 324 for displaying posted virtual teams 366-268 to users. In some examples, the posted virtual team display 324 is included in or otherwise associated with a system such as system 100 of FIG. 1.

As with the candidate virtual team display 220, the posted virtual team display 324 includes a user information section 364 and posted virtual teams 366 and 368, as illustrated. The user information section 364 includes a user name, a user role, and user contact information. It should be understood that the user information section 364, in other examples, includes a variety of user information as described above with respect to the user information section 226. Further, in some examples, the type of user information displayed in the user information section 364 differs depending on whether a first user is viewing user information about themselves or a second user is viewing information about the first user. Other users viewing information about another user may be provided limited user information based on user preferences, system rules, or the like.

The posted virtual teams 366 and 368 include user IDs 370 and 376, activity links 372 and 378, and activity keywords 374 and 380, respectively. In some examples, these data are displayed in substantially the same way as the data of the candidate virtual teams 228 and 230 of FIG. 2A. Further, in other examples, more, less, or different information of the posted virtual teams 366 and 368 is displayed without departing from the description.

In some examples, the posted virtual team display 324 includes or is associated with a variety of different views. In an example, a user-specific view provides information about a specific user and the posted virtual teams to which that user belongs, as illustrated in FIG. 3. Further, in such examples, the user-specific view highlights virtual teams that the viewing user shares with the displayed user, enabling the viewing user to quickly identify relationships with the displayed user. Alternatively, or additionally, in another example, a virtual team-specific view provides information about a specific virtual team with links to the members of the team, activities performed by members of the team, documents or other items generated by members of the team or the like. In such examples, the display 324 is configured to enable a user to switch between such views by clicking on or otherwise activating portions of the interface, such as by activating a portion of the interface associated with a specific virtual team, the virtual team-specific view of that team is displayed and, by activating a portion of the interface associated with a specific user, the user-specific view of that user is displayed.

Further, in some examples, the posted virtual team display 324 enables users viewing it to interact with members of the virtual teams more efficiently. In an example, a user is enabled to activate a contact link for a posted virtual team, causing an email or other similar communication interface to be displayed that enables the user to contact the members of the posted virtual team. Additionally, or alternatively, the posted virtual team display 324 enables a user to more efficiently find existing virtual teams based on searching for keywords or the like.

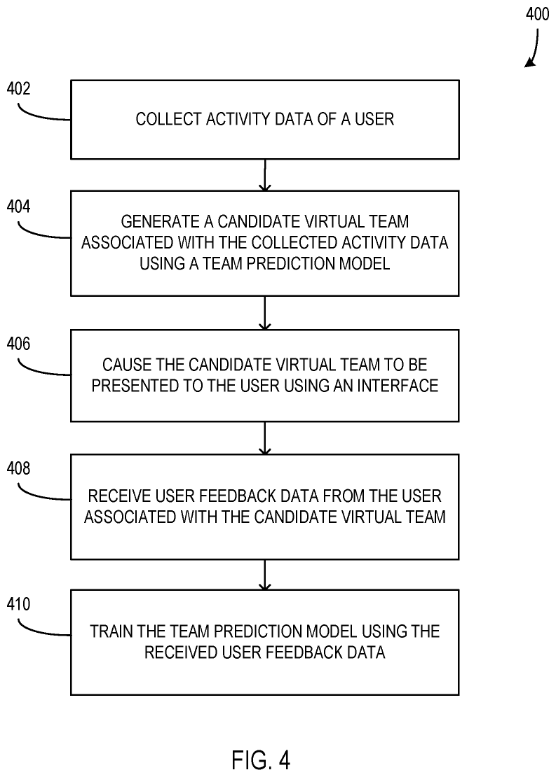

FIG. 4 is a flowchart illustrating a computerized method 400 for generating a candidate virtual team (e.g., candidate virtual team 118) using a team prediction model (e.g., team prediction model 116) and training the team prediction model based on user feedback data (e.g., user feedback 122). In some examples, the method 400 is executed or otherwise performed by or in association with a system such as system 100 of FIG. 1.

At 402, activity data of a user is collected. In some examples, the activity data is collected as the user performs activities using an associated system. Further, in such examples, the activity data includes data associated with activities such as meetings, projects, tasks, communication such as email or instant messaging, generation, viewing, or editing of documents or other items, or the like. In an example, the collected activity data includes activity data associated with at least one of the following types of activities: a meeting activity including multiple users in attendance; a task activity associated with a task assigned to the user; a document generation activity in which the user engaged; and a communication activity between multiple users.

At 404, a candidate virtual team is generated in association with the collected activity data using a team prediction model. In some examples, the candidate virtual team is further generated based on a set of activity data that is associated with a plurality of different users, including users with which the user has shared activities. Further, in such examples, the team prediction model is a neural network or other model that is generated and trained using machine learning techniques. Additionally, or alternatively, multiple candidate virtual teams are generated by the model using the collected activity data and/or other collected activity data.

At 406, the candidate virtual team is caused to be presented to the user using an interface. In some examples, the candidate virtual team is displayed on a GUI. Alternatively, or additionally, in other examples, the candidate virtual team is presented to the user via a text-based interface, an email, a document, or other non-graphical interface. Further, in some examples, the interface is configured to enable the user to interact with the presented candidate virtual team as described herein, including enabling the user to accept the candidate virtual team, reject the candidate virtual team, and/or edit the candidate virtual team.

At 408, user feedback data associated with the candidate virtual team is received from the user. In some examples, the user is enabled to provide the user feedback data via an interface, such as a virtual team editing display 244 as described herein. Further, in such examples, the received user feedback data includes an acceptance indicator indicating that the user accepts the generated candidate virtual team, a rejection indicator indicating that the user rejects the generated candidate virtual team, and/or editing data indicating how the user edited the generated candidate virtual team. Further, in some examples where the user feedback data includes editing data, it includes editing data indicating that the user edited the set of members of the candidate virtual team, editing data indicating that the user edited a title of the candidate virtual team, editing data indicating that the user edited a keyword of the candidate virtual team, or the like.

At 410, the team prediction model is trained using the received user feedback data. In some examples, the training of the team prediction model is performed using machine learning techniques, such as the training processes described herein. In an example, weights within the team prediction model are adjusted such that the team prediction model generates candidate virtual teams that more closely correspond with the received user feedback data.

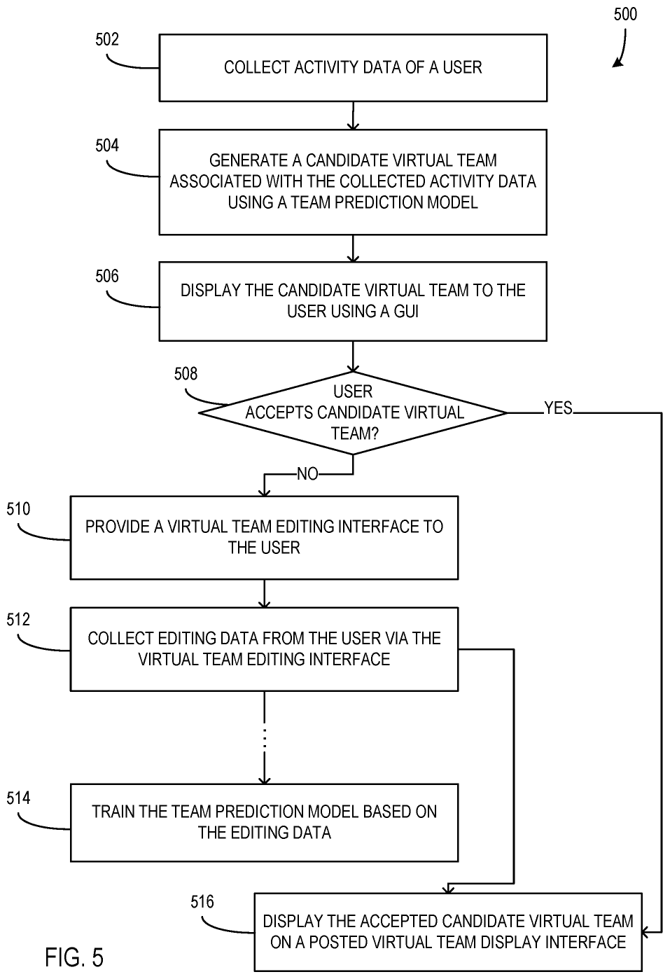

FIG. 5 is a flowchart illustrating a computerized method 500 for training and generating a candidate virtual team (e.g., candidate virtual team 118) using a team prediction model (e.g., team prediction model 116) and enabling the user (e.g., user 102) to edit the candidate virtual team. In some examples, the method 500 is executed or otherwise performed by or in association with a system such as system 100 of FIG. 1.

At 502, activity data of a user is collected and, at 504, a candidate virtual team associated with the collected activity data is generated using a team prediction model. In some examples, 502-504 is performed in substantially the same manner as 402-404.

At 506, the candidate virtual team is displayed to the user using a GUI (e.g., the candidate virtual team display 220). In some examples, the GUI displays the candidate virtual team to the user in addition to other information, such as user information and/or information associated with other virtual teams. Further, in such examples, the GUI enables the user to interact with the candidate virtual team, such as by viewing additional information, accepting the candidate virtual team, rejecting the candidate virtual team, and/or editing the candidate virtual team as described herein.

At 508, if the user accepts the candidate virtual team, the process proceeds to 516. Alternatively, if the user does not accept the candidate virtual team, the process proceeds to 510. In some examples, the user is enabled to accept, reject, or edit the candidate virtual team using interface components of the GUI, such as buttons, or the like.

At 510, a virtual team editing interface (e.g., virtual team editing display 244) is provided to the user. In some examples, the virtual team editing interface displays data associated with the candidate virtual team and interface components that enable the user to edit the data of the candidate virtual team. In some examples, the virtual team editing interface displays a list of members of the candidate virtual team and interface components that enable the user to add, remove, or otherwise change the list of members. In other examples, other interface components included in the virtual team editing interface without departing from the description.

At 512, editing data is collected from the user via the virtual team editing interface. In some examples, the editing data indicates changes to the list of members of the candidate virtual team. After editing the team, in some examples, the user selects to post the modified team, such that the process proceeds to 516. Further, the editing data and any associated metadata is stored in the system for use as training data as described herein.

At some later point, at 514, the team prediction model is trained based on the editing data and/or other collected training data. The training of the team prediction model improves the likelihood that the team prediction model will generate similar candidate virtual teams from similar sets of activity data in the future.

At 516, the accepted candidate virtual team is displayed on a posted virtual team display interface (e.g., the posted virtual team display 324). In some examples, displaying the accepted candidate virtual team includes displaying some or all of the members of the candidate virtual team, a title of the virtual team, activity links associated with the virtual team, and/or activity keywords associated with the virtual team as described herein.

Further, in some examples, the virtual team is published to a set of publicly viewable virtual teams, such that other users are enabled to view and/or otherwise access it. In such examples, the published virtual team is presented to another user via the posted virtual team display interface based on the other user searching for or otherwise navigating to the published virtual team based on the members, activity links, and/or activity keywords thereof.

Additionally, or alternatively, in some examples, the posted virtual team display interface includes at least one of an interface component enabling the other user to view data of members of the published virtual team, an interface component enabling the other user to view a set of published virtual teams that the other user shares with the user, and/or an interface component enabling the other user to communicate with the members of the published virtual team as a team.

### Additional Examples

In an example, a GUI displays a user profile of a user named Claire. The GUI includes an organization explorer portion that displays information about Claire specifically as well as team members that are part of Claire's team within the organization. Further, the GUI includes a portion that displays “collabs”, which are virtual teams that Claire is a part of, with each collab including information such as the names of other virtual team members and keywords with which the collab is associated. Some of the collabs have been accepted by Claire and/or other members of the collab, while others are “suggested collabs”, or candidate virtual teams generated by a team prediction model as described herein. The suggested collabs are highlighted to Claire, notifying her that she can review them for accuracy, make changes to them, accept them, or reject them.

When Claire clicks on or otherwise activates one of the suggested collabs, a second GUI is displayed that enables Claire to view the details of the suggested collab more completely and to make changes to the collab. Claire is provided with GUI elements that enable her to add and/or remove members from the collab, to change the title of the collab, and/or to add, remove, or change keywords associated with the collab. When she is done with making any changes, Claire is prompted to accept or reject the collab that reflects the changes she made. If she accepts it, in some examples, she is further prompted to choose whether to publish the collab (e.g., make it public such that users outside of the collab can view it) or not. Further, in such examples, Claire is enabled to select who can view the accepted collab more granularly, such as by selecting whether certain user roles or levels within the organization can view the collab. Additionally, or alternatively, in some examples, the users of the collab can include people that are outside the organization, such as consultants that work with external customer users or other employees working with external vendors.

Further, when Claire chooses to publish the collab, it becomes viewable and/or searchable by other users in the organization. When others view Claire's profile page, the collab will be displayed in a specific collab section and, when others search for keywords that match those of the collab, it will appear in the search results. Alternatively, or additionally, if Claire has configured the exposure of the collab to be limited, it only appears to users that satisfy those limitations. In an example, the collab is only viewable by users in the Engineering Division and not to users in the Marketing Division in a company.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hardcoded machine. In some examples, platform software comprising an operating system 620 or any other suitable platform software is provided on the apparatus 618 to enable application software 621 to be executed on the device. In some examples, generating candidate virtual teams using a team prediction model and training that team prediction model based on user feedback to the generated candidate virtual teams as described herein is accomplished by software, hardware, and/or firmware.

In some examples, computer executable instructions are provided using any computer-readable media that are accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; a graphical user interface (GUI); and a memory comprising computer program code, the memory and the computer program code configured to, with the processor, cause the processor to: collect activity data, wherein the activity data includes activity data associated with activities in which a set of users have engaged; generate a candidate virtual team associated with the collected activity data using a team prediction model, wherein the candidate virtual team includes at least one user from the set of users; cause the generated candidate virtual team to be presented using the GUI; receive user feedback data associated with the generated candidate virtual team; and train the team prediction model using the received user feedback data, whereby accuracy of future generated candidate virtual teams generated by the team prediction model is improved due to the training.

An example computerized method comprises: collecting activity data, wherein the activity data includes activity data associated with activities in which a set of users have engaged; generating a candidate virtual team associated with the collected activity data using a team prediction model, wherein the candidate virtual team includes at least one user from the set of users; causing the generated candidate virtual team to be presented using an interface; receiving user feedback data associated with the generated candidate virtual team from the interface; and training the team prediction model using the received user feedback data, whereby accuracy of future generated candidate virtual teams generated by the team prediction model is improved due to the training.

One or more computer storage media have computer-executable instructions that, upon execution by a processor, cause the processor to at least: collect activity data, wherein the activity data includes activity data associated with activities in which a set of users have engaged; generate a candidate virtual team associated with the collected activity data using a team prediction model, wherein the candidate virtual team includes at least one user from the set of users; cause the generated candidate virtual team to be presented using an interface; receive user feedback data associated with the generated candidate virtual team from the interface; and train the team prediction model using the received user feedback data, whereby accuracy of future generated candidate virtual teams generated by the team prediction model is improved due to the training.

Alternatively, or in addition to the other examples described herein, examples include any combination of the following:
wherein the received user feedback data includes at least one of the following: an acceptance indicator indicating user acceptance of the generated candidate virtual team; a rejection indicator indicating user rejection of the generated candidate virtual team; and editing data indicating user edits made to the generated candidate virtual team.
wherein the received user feedback data includes editing data that includes at least one of the following: editing data indicating editing of the set of members of the candidate virtual team; editing data indicating editing of a title of the candidate virtual team; and editing data indicating editing of a keyword of the candidate virtual team.
wherein the received user feedback data includes an acceptance indicator; and wherein the computerized method further comprises: publishing the candidate virtual team to a set of publicly viewable virtual teams; and causing the published virtual team to be presented to a user that is not a member of the published virtual team.
further comprising presenting the user with a set of interface components including at least one of the following: an interface component enabling the user to view data of members of the published virtual team; an interface component enabling the user to view a set of published virtual teams that the user shares with a member of the published virtual team; and an interface component enabling the user to communicate with the members of the published virtual team as a team.
wherein causing the generated candidate virtual team to be presented using the interface includes causing at least one of the following to be presented: user IDs of members of the generated candidate virtual team; links to activities with which members of the generated candidate virtual team have engaged; and keywords associated with activities with which members of the generated candidate virtual team have engaged.
wherein the collected activity data includes activity data associated with at least one of the following types of activities: a meeting activity including multiple users in attendance; a task activity associated with a task assigned to a user; a document generation activity in which a user engaged; and a communication activity between multiple users.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for collecting activity data, wherein the activity data includes activity data associated with activities in which a set of users have engaged; exemplary means for generating a candidate virtual team associated with the collected activity data using a team prediction model, wherein the candidate virtual team includes at least one user from the set of users; exemplary means for causing the generated candidate virtual team to be presented using an interface; exemplary means for receiving user feedback data associated with the generated candidate virtual team from the interface; and exemplary means for training the team prediction model using the received user feedback data, whereby accuracy of future generated candidate virtual teams generated by the team prediction model is improved due to the training.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor;
a graphical user interface (GUI); and
a memory comprising computer program code, the memory and the computer program code configured to, with the processor, cause the processor to:
collect activity data, wherein the activity data includes activity data associated with activities in which a set of users have engaged;
generate a candidate virtual team associated with the collected activity data using a team prediction model, wherein the candidate virtual team includes at least one user from the set of users;
cause the generated candidate virtual team to be presented using the GUI;
receive user feedback data associated with the generated candidate virtual team; and
train the team prediction model using the received user feedback data, whereby accuracy of future generated candidate virtual teams generated by the team prediction model is improved due to the training.

2. The system of claim 1, wherein the received user feedback data includes at least one of the following: an acceptance indicator indicating user acceptance of the generated candidate virtual team; a rejection indicator indicating user rejection of the generated candidate virtual team; editing data indicating user edits made to the generated candidate virtual team.

3. The system of claim 2, wherein the received user feedback data includes editing data that includes at least one of the following: editing data indicating editing of the set of members of the candidate virtual team; editing data indicating editing of a title of the candidate virtual team; editing data indicating editing of a keyword of the candidate virtual team.

4. The system of claim 2, wherein the received user feedback data includes an acceptance indicator; and
wherein the memory and the computer program code are configured to, with the processor, further cause the processor to:
publish the candidate virtual team to a set of publicly viewable virtual teams; and
cause the published virtual team to be presented to a user that is not a member of the published virtual team.

5. The system of claim 4, wherein the memory and the computer program code are configured to, with the processor, further cause the processor to present a set of GUI components including at least one of the following: a GUI component enabling viewing of data of members of the published virtual team; a GUI component enabling viewing of a set of published virtual teams that the user shares with a member of the published virtual team; a GUI component enabling communication with the members of the published virtual team as a team.

6. The system of claim 1, wherein causing the generated candidate virtual team to be presented using the GUI includes causing at least one of the following to be presented: user IDs of members of the generated candidate virtual team; links to activities with which members of the generated candidate virtual team have engaged; keywords associated with activities with which members of the generated candidate virtual team have engaged.

7. The system of claim 1, wherein the collected activity data includes activity data associated with at least one of the following types of activities: a meeting activity including multiple users in attendance; a task activity associated with a task assigned to a user; a document generation activity in which a user engaged; a communication activity between multiple users.

8. A computerized method comprising:
collecting activity data, wherein the activity data includes activity data associated with activities in which a set of users have engaged;
generating a candidate virtual team associated with the collected activity data using a team prediction model, wherein the candidate virtual team includes at least one user from the set of users;
causing the generated candidate virtual team to be presented using an interface;
receiving user feedback data associated with the generated candidate virtual team from the interface; and
training the team prediction model using the received user feedback data.

9. The computerized method of claim 8, wherein the received user feedback data includes at least one of the following: an acceptance indicator indicating user acceptance of the generated candidate virtual team; a rejection indicator indicating user rejection of the generated candidate virtual team; editing data indicating user edits made to the generated candidate virtual team.

10. The computerized method of claim 9, wherein the received user feedback data includes editing data that includes at least one of the following: editing data indicating editing of the set of members of the candidate virtual team; editing data indicating editing of a title of the candidate virtual team; editing data indicating editing of a keyword of the candidate virtual team.

11. The computerized method of claim 9, wherein the received user feedback data includes an acceptance indicator; and
wherein the computerized method further comprises:
publishing the candidate virtual team to a set of publicly viewable virtual teams; and
causing the published virtual team to be presented to a user that is not a member of the published virtual team.

12. The computerized method of claim 11, further comprising presenting the user with a set of interface components including at least one of the following: an interface component enabling the user to view data of members of the published virtual team; an interface component enabling the user to view a set of published virtual teams that the user shares with a member of the published virtual team; an interface component enabling the user to communicate with the members of the published virtual team as a team.

13. The computerized method of claim 8, wherein causing the generated candidate virtual team to be presented using the interface includes causing at least one of the following to be presented: user IDs of members of the generated candidate virtual team; links to activities with which members of the generated candidate virtual team have engaged; keywords associated with activities with which members of the generated candidate virtual team have engaged.

14. The computerized method of claim 8, wherein the collected activity data includes activity data associated with at least one of the following types of activities: a meeting activity including multiple users in attendance; a task activity associated with a task assigned to a user; a document generation activity in which a user engaged; a communication activity between multiple users.

15. One or more computer storage media having computer-executable instructions that, upon execution by a processor, cause the processor to at least:
collect activity data, wherein the activity data includes activity data associated with activities in which a set of users have engaged;
generate a candidate virtual team associated with the collected activity data using a team prediction model, wherein the candidate virtual team includes at least one user from the set of users;
cause the generated candidate virtual team to be presented using an interface;
receive user feedback data associated with the generated candidate virtual team from the interface; and
train the team prediction model using the received user feedback data.

16. The one or more computer storage media of claim 15, wherein the received user feedback data includes at least one of the following: an acceptance indicator indicating user acceptance of the generated candidate virtual team; a rejection indicator indicating user rejection of the generated candidate virtual team; editing data indicating user edits made to the generated candidate virtual team.

17. The one or more computer storage media of claim 16, wherein the received user feedback data includes editing data that includes at least one of the following: editing data indicating editing of the set of members of the candidate virtual team; editing data indicating editing of a title of the candidate virtual team; editing data indicating editing of a keyword of the candidate virtual team.

18. The one or more computer storage media of claim 16, wherein the received user feedback data includes an acceptance indicator; and
wherein the computer-executable instructions, upon execution by a processor, further cause the processor to at least:
publish the candidate virtual team to a set of publicly viewable virtual teams; and
cause the published virtual team to be presented to a user that is not a member of the published virtual team.

19. The one or more computer storage media of claim 18, wherein the computer-executable instructions, upon execution by a processor, further cause the processor to at least present the user with a set of interface components including at least one of the following: an interface component enabling the user to view data of members of the published virtual team; an interface component enabling the user to view a set of published virtual teams that the user shares with a member of the published virtual team; an interface component enabling the user to communicate with the members of the published virtual team as a team.

20. The one or more computer storage media of claim 15, wherein causing the generated candidate virtual team to be presented using the interface includes causing at least one of the following to be presented: user IDs of members of the generated candidate virtual team; links to activities with which members of the generated candidate virtual team have engaged; keywords associated with activities with which members of the generated candidate virtual team have engaged.
